(19) United States
(12) Patent Application Publication
(10) Pub. No.: US 2025/0226162 A1
(43) Pub. Date: Jul. 10, 2025

(54) ELECTRONIC APPARATUS AND INPUT DEVICE

(71) Applicant: SONY GROUP CORPORATION, TOKYO (JP)

(72) Inventors: KENSHIRO OTSUKI, TOKYO (JP); TAKAHIRO TOMITA, TOKYO (JP); WATARU NAKANO, TOKYO (JP); YUSUKE OHNISHI, TOKYO (JP)

(21) Appl. No.: 18/701,794

(22) PCT Filed: Sep. 20, 2022
(86) PCT No.: PCT/JP2022/034865

§ 371 Date: Apr. 16, 2024

(30) Foreign Application Priority Data
Oct. 25, 2021 (JP) 2021-174169

(51) Int. Cl. H01H 13/14; G06F 3/02; H01H 13/06

(52) U.S. Cl. CPC H01H 13/14; H01H 13/06; G06F 3/0202

(57) ABSTRACT

An electronic apparatus (200) includes a casing (201), an operation key (10), a support (20), and a gasket member (30). The casing (201) has an opening portion (230h) long in a first axis (X-axis) direction and short in a second axis (Z-axis) direction. The operation key (10) includes a key body (11) that is fitted in the opening portion (230h) and a pair of flange portions (12) respectively provided at both ends of the key body (11) in a long direction. The support (20) is arranged inside the casing (201) and includes a switch element for detecting a press operation on the operation key (10). The gasket member (30) includes a movable portion (31), a pair of fixed portions (32), and a deformation layer (33). The pair of fixed portions (32) is arranged between the casing (201) and the support (20) and respectively includes recess portions (32a) that the pair of flange portions (12) enters at a time of the press operation on the operation key (10).

### TECHNICAL FIELD

The present technology relates to an electronic apparatus and a switch device with a press operation key.

### BACKGROUND ART

For example, electronic apparatuses such as digital cameras, video cameras, and mobile phones each provided with an input device with press operation keys have been widely known (e.g., see Patent Literature 1).

### CITATION LIST

### Patent Literature

Patent Literature 1: Japanese Patent Application Laid-open No. 2009-193467

### DISCLOSURE OF INVENTION

### Technical Problem

Along with reduction in size and thickness of electronic apparatuses in recent years, press operation keys arranged in their casings tend to be downsized. In particular, a thin electronic apparatus such as a smartphone is required to ensure favorable operability of a press operation key arranged in a limited space, e.g., a side surface portion of a casing.

In view of the above-mentioned circumstances, it is an objective of the present technology to provide an electronic apparatus and an input device that are capable of ensuring favorable operability of a press operation key arranged in a limited space of a casing.

### Solution to Problem

An electronic apparatus according to an embodiment of the present technology includes a casing, an operation key, a support, and a gasket member.

The casing has an opening portion long in a first axis direction and short in a second axis direction orthogonal to the first axis.

The operation key includes a key body that is fitted in the opening portion and is long in the first axis direction, and a pair of flange portions respectively provided at both ends of the key body in a long direction and projecting in parallel with the first axis direction inside the casing.

The support is arranged inside the casing and includes a switch element for detecting a press operation on the operation key in a third axis direction orthogonal to the first axis and the second axis.

The gasket member includes a movable portion, a pair of fixed portions, and a deformation layer. The movable portion is arranged between the key body and the switch element and receives a pressing force along the third axis direction from the operation key and comes into contact with the switch element. The pair of fixed portions is arranged between the casing and the support and respectively includes recess portions that the pair of flange portions enters at a time of the press operation on the operation key. The deformation layer supports the movable portion and the pair of fixed portions and is formed of an elastic material.

In such an electronic apparatus, the pair of fixed portions of the gasket member is provided with the recess portions that allow the pair of flange portions to enter the recess portions when the operation key is pressed. Therefore, it is possible to prevent the contact between the flange portions and the fixed portions from obstructing the contact between the movable portion and the switch element. Accordingly, even in a case where the input device is formed in a limited region inside the casing, a stroke required for the press operation on the operation key is ensured and favorable operability of the input device can be realized.

The deformation layer may include a first elastic portion that supports the movable portion and biases the operation key in a direction away from the switch element, and a pair of second elastic portions that supports the pair of fixed portions and seals a gap between the casing and the support.

The first elastic portion may have a curve portion which is provided in an annular shape along a periphery of the movable portion and has a shape protruding toward the key body.

The gasket member may further include a pair of restriction portions that is opposite to each other in the second axis direction with the movable portion provided therebetween and restricts a tilt of the key body around the first axis.

The operation key may further include a projection that comes into contact with the movable portion provided in a bottom portion of the key body, and the projection may include a first flat plate portion extending in the first axis direction, and a second flat plate portion intersecting with the first flat plate portion and extending in the second axis direction.

The casing may include a length direction in parallel with the first axis direction, a thickness direction in parallel with the second axis direction, and a width direction in parallel with the third axis direction, and the opening portion may be formed in one side surface portion of the casing.

An input device according to an embodiment of the present technology, which is a switch device arranged in a casing with an opening portion long in a first axis direction and short in a second axis direction orthogonal to the first axis, including an operation key, a support, and a gasket member.

The operation key includes a key body that is fitted in the opening portion and is long in the first axis direction, and a pair of flange portions respectively provided at both ends of the key body in a long direction and projecting in parallel with the first axis direction inside the casing.

The support is arranged inside the casing and installs a switch element for detecting a press operation on the operation key in a third axis direction orthogonal to the first axis and the second axis.

The gasket member includes a movable portion that is arranged between the key body and the switch element and receives a pressing force along the third axis direction from the operation key and comes into contact with the switch element, a pair of fixed portions that is arranged between the casing and the support and respectively includes recess portions that the pair of flange portions enters at a time of the press operation on the operation key, and a deformation layer that supports the movable portion and the pair of fixed portions and is formed of an elastic material.

### BRIEF DESCRIPTION OF DRAWINGS

FIG. 1 A perspective view showing an electronic apparatus according to the present embodiment.

FIG. 2 A cross-sectional view of an input device according to the present embodiment.

FIG. 3 Another cross-sectional view of the input device.

FIG. 4 A perspective view of an operation key in the input device when viewed from the bottom.

FIG. 5 A top view of a gasket member in the input device when viewed from the operation key side.

FIG. 6 A bottom view of the gasket member when viewed from the support side.

FIG. 7 A perspective view of the gasket member when viewed from an upper surface side.

FIG. 8 A cross-sectional view showing an operation example of the input device.

### MODE(S) FOR CARRYING OUT THE INVENTION

Hereinafter, embodiments according to the present technology will be described with reference to the drawings.

### Electronic Apparatus

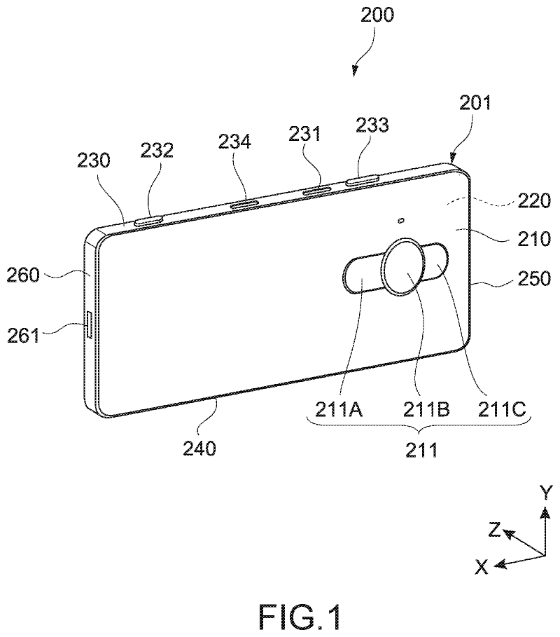

FIG. 1 is a perspective view showing an electronic apparatus 200 according to the present embodiment. In the figure, an X-axis, a Y-axis, and a Z-axis denote three axis directions orthogonal to one another and the X-axis direction corresponds to a long direction of the electronic apparatus 200, the Y-axis direction corresponds to a short direction of the electronic apparatus 200, and the Z-axis direction corresponds to a thickness direction of the electronic apparatus 200. First of all, an overall configuration of the electronic apparatus 200 will be described.

The electronic apparatus 200 includes a first main surface 210 and a second main surface 220 which are rectangular. The second main surface 220 is a back surface of the first main surface 210 and has the same shape as the first main surface 210. The electronic apparatus 200 further includes a pair of long side surfaces 230 and 240 connecting the first main surface 210 and the second main surface 220 and a pair of short side surfaces 250 and 260 connecting the first main surface 210 and the second main surface 220. The pair of long side surfaces 230 and 240 connects long sides of the first main surface 210 and the second main surface 220, which are rectangular, to each other. The pair of short side surfaces 250 and 260 connects short sides of the first main surface 210 and the second main surface 220, which are rectangular, to each other. The first main surface 210 and the second main surface 220, the pair of long side surfaces 230 and 240, and the pair of short side surfaces 250 and 260 constitute a casing 201 of the electronic apparatus 200.

The first main surface 210 includes one or more first imaging units 211. In this example, the first main surface 210 includes three first imaging units 211. The three first imaging units 211 are a telephoto imaging unit 211A, a normal imaging unit 211B, and an ultra wide-angle imaging unit. The telephoto imaging unit 211A, the normal imaging unit 211B, and the ultra wide-angle imaging unit 211C in the stated order are arranged in line in parallel with the X-axis direction, directed toward one of the short side surfaces 250 from inside of the first main surface 210.

The second main surface 220 has a second imaging unit for selfie for example (not shown) other than a display unit such as a liquid-crystal display or an organic EL display. The display unit includes, for example, a capacitive touch sensor. The display unit displays an image captured through the first imaging unit 211 or the second imaging unit.

One long side surface 230 of the casing 201 has a plurality of keys such as a power key 231, a camera key 232, a sound volume key 233, and a voice assistant activation key 234. One short side surface 260 has a port 261 for inserting a cable 400. An antenna (not shown) is built in the electronic apparatus 200, near the one short side surface 260.

### Input Device

Subsequently, an input device according to the present embodiment will be described. Here, the input device according to the present embodiment will be described, for example, taking the camera key 232 as an example.

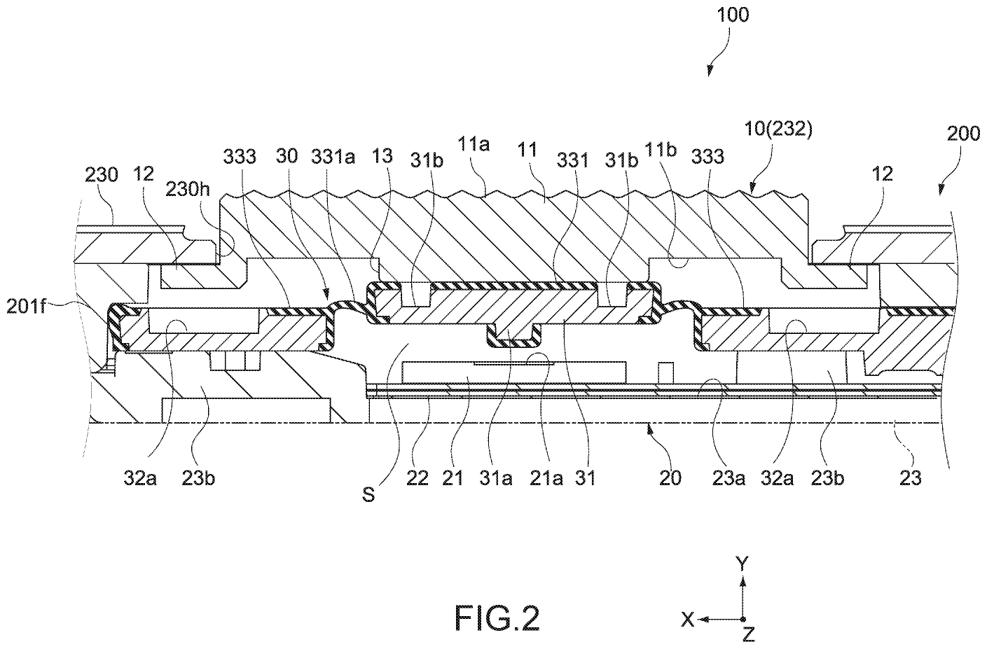

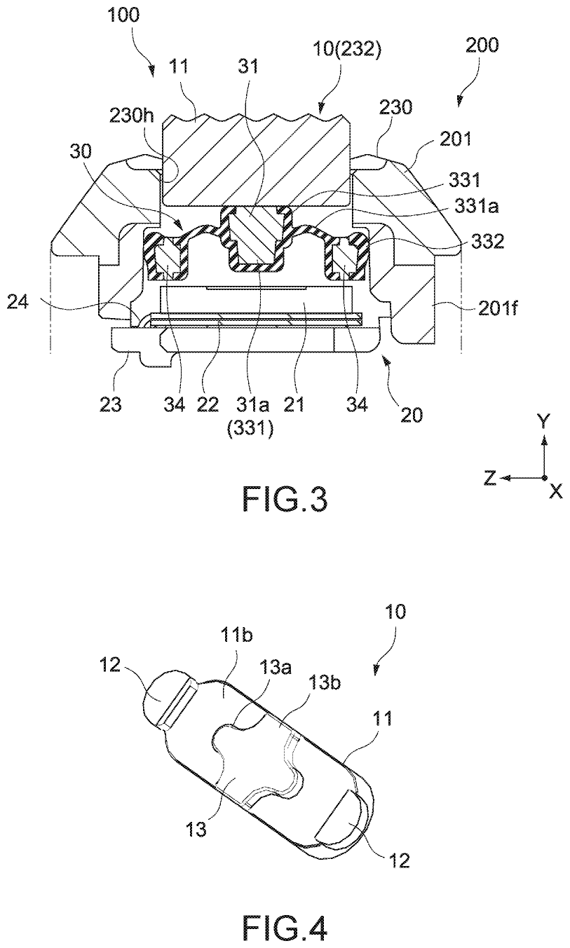

FIG. 2 is a cross-sectional view of main parts of an input device 100 according to the present embodiment, which is taken along an XY-plane. FIG. 3 is a cross-sectional view of main parts of the input device 100, which is taken along a YZ-plane.

The input device 100 includes an operation key 10 corresponds to the camera key 232, a support 20 having a switch element 21 that detects a press operation on the operation key 10, and a gasket member 30 arranged between the operation key 10 and the support 20.

The operation key 10 is arranged in an opening portion 230h formed in the long side surface 230 of the casing 201. The opening portion 230h has an elliptical shape long in the X-axis direction and short in the Z-axis direction and penetrates the long side surface 230 in the Y-axis direction. The operation key 10 is a molded body formed of a synthetic resin material or metal material and includes a key body 11 long in the X-axis direction, which is fitted in the opening portion 230h, and a pair of flange portions 12 provided at both ends of the key body 11 in the long direction.

The key body 11 is a cube having a flat plate shape similar to the opening portion 230h and has an operation surface 11a pressed by the user and a bottom surface 11b on its opposite side. A projection 13 supported by a movable portion 31 of the gasket member 30 is provided at a center portion of the bottom surface 11b of the key body 11.

FIG. 4 is a perspective view of the operation key 10 when viewed from the bottom. The projection 13 projects toward the gasket member 30 from a bottom surface 12b of the key body 11. The projection 13 includes a first flat plate portion 13a extending in the long direction (X-axis direction) of the key body 11 and a second flat plate portion 13b intersecting with the first flat plate portion 13a and extending in the short direction (Z-axis direction) of the key body 11. A length of the first flat plate portion 13a in the X-axis direction is set to be about a half of the length of the key body 11 in the long direction. A length of the second flat plate portion 13b in the Z-axis direction is set to equal the length of the key body 11 in the short direction.

The pair of flange portions 12 projects from the bottom surface portion 12b at both end portions of the key body 11 in the long direction in parallel with the X-axis direction inside the casing 201. The pair of flange portions 12 functions as a stopper for preventing the operation key 10 from moving out from the opening portion 230h in such a manner that their upper surfaces (surfaces on the operation surface 11a side) face an inner surface of the long side surface 230 of the casing 201 and come into contact with the inner surface of the long side surface 230.

The support 20 includes a circuit board 22 on which the switch element 21 is mounted and a base member 23 that supports the circuit board 22.

The switch element 21 is arranged to face the projection 13 of the operation key 10 in the Y-axis direction. The switch element 21 has a pressure-sensitive portion 21a that closes when it detects a predetermined contact pressure or more with the movable portion 31 of the gasket member 30 that moves in the Y-axis direction together with the operation key 10 due to a press operation on the operation key 10. It should be noted that the present technology is not limited thereto, and the switch element 21 may be another switch that electrically, magnetically, or optically detects a contact with the movable portion 31.

The circuit board 22 outputs a press operation on the operation key 10 which has been detected by the switch element 21 to a control unit (not shown) inside the electronic apparatus 200. The control unit is a control circuit such as a CPU that controls the operation of the electronic apparatus 200. The control circuit and the circuit board 22 are electrically connected to each other via a wire material 24 (see FIG. 3) such as a flexible wiring board.

The base member 23 is fixed inside the casing 201 and forms a housing space S for the gasket member 30 and the circuit board 22 inside the long side surface 230. A region of the base member 23 other than the housing space S is connected to a frame portion 201f forming an inner peripheral portion of the casing 201. The base member 23 has, for example, a seat portion 23b (see FIG. 2) having a predetermined shape that supports the gasket member 30 other than a support surface 23a that supports the circuit board 22.

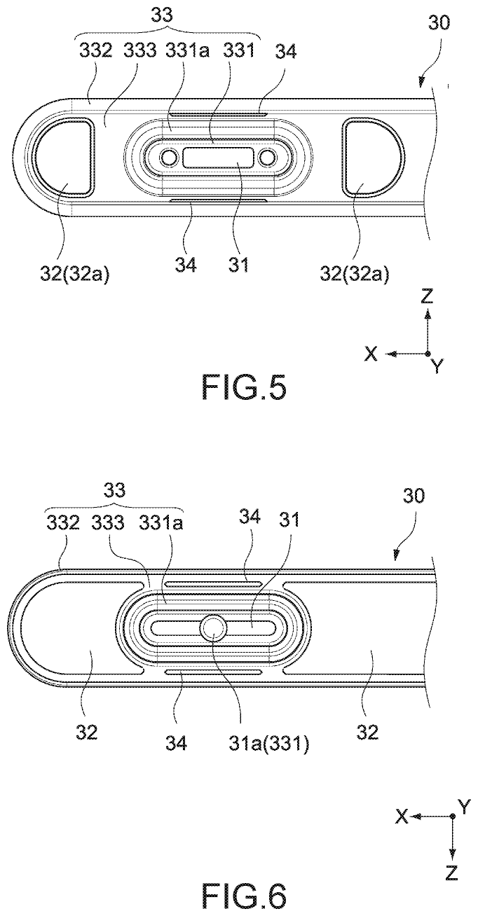

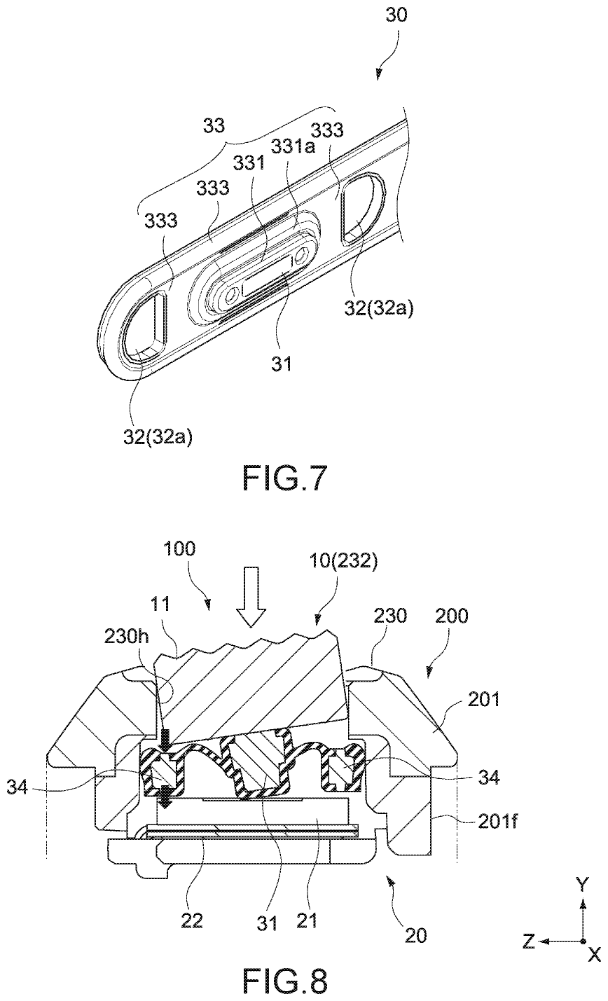

Subsequently, the gasket member 30 will be described. FIG. 5 is a top view of the gasket member 30 when viewed from the operation key 10 side. FIG. 6 is a bottom view of the gasket member 30 when viewed from the support 20 side. FIG. 7 is a perspective view of the gasket member 30 when viewed from the upper surface side.

The gasket member 30 includes the movable portion 31, a pair of fixed portions 32, and a deformation layer 33.

The movable portion 31 is arranged between the key body 11 of the operation key 10 and the switch element 21. The movable portion 31 receives a pressing force along the Y-axis direction from the operation key 10 and comes into contact with the switch element 21. The movable portion 31 is a plate-like molded body made of a synthetic resin long in the X-axis direction and is slightly longer than the first flat plate portion 13a of the projection 13 of the operation key 10. A protrusion portion 31a that projects toward the pressure-sensitive portion 21a of the switch element 21 is provided in the bottom portion of the movable portion 31. It should be noted that two recess portions 31b formed in the surface of the movable portion 31 are insertion holes at end portions of positioning pins for retaining the movable portion 31 in a mold when the gasket member 30 is molded.

The fixed portions 32 in a pair are opposite to each other in the X-axis direction with the movable portion 31 provided therebetween. The pair of fixed portions 32 is arranged between the long side surface portion 230, which is the casing 201, and the support 20. The pair of fixed portions 32 is coupled to the movable portion 31 via the deformation layer 33. The pair of fixed portions 32 is a plate-like molded body made of a synthetic resin parallel to the XZ-plane and is fixed between the frame portion 201f of the casing 201 and the support portion 20.

The pair of fixed portions 32 respectively includes recess portions 32a that the pair of flange portions 12 enters at the time of a press operation on the operation key 10. The recess portions 32a are bottomed, recessed portions provided in upper surfaces of the fixed portions 32. The recess portions 32a are formed such that the size of each recess portion 32a is larger than the outer diameter of each flange portion 12 and each recess portion 32a has a depth that it does not come into contact with each flange portion 12 when the operation key 10 is pressed in the Y-axis direction so that the switch element 21 is closed.

The deformation layer 33 is formed of an elastic material such as a synthetic rubber and supports the movable portion 31 and the pair of fixed portions 32. The deformation layer 33 is a rubber film formed with a constant or substantially constant thickness and is integrally molded with the movable portion 31 and the pair of fixed portions 32, thereby forming the gasket member 30 formed of a single component. The deformation layer 33 has an elliptical shape long in the X-axis direction and is arranged in the housing space S inside the casing 201. The deformation layer 33 includes a first elastic portion 331, a second elastic portion 332, and a third elastic portion 333.

The first elastic portion 331 supports the movable portion 31 and biases the operation key 10 in a direction away from the switch element 10. The first elastic portion 331 covers the periphery of the movable portion 31 and its front and rear part, thereby supporting the movable portion 31. The first elastic portion 331 covers the protrusion portion 31a formed in the bottom portion of the movable portion 31, thereby reducing a physical load to the switch element 10 and making the key operability favorable.

The first elastic portion 331 has a curve portion 331a provided in an annular shape along the periphery of the movable portion 31. The curve portion 331a is formed in a curve shape protruding toward the key body 11. The movable portion 31 is supported by the first elastic portion 331 to be deformable in six axis directions (in the X-axis direction, in the Y-axis direction, in the Z-axis direction, around the X-axis, around the Y-axis, and around the Z-axis) from its peripheral region.

The second elastic portion 332 supports the pair of fixed portions 32 and seals a gap between the frame portion 201f of the casing 201 and the support 20. The second elastic portion 332 forms a rim portion of the gasket member 30 and covers the periphery of the pair of fixed portions 32. The second elastic portion 332 is sandwiched between the frame portion 201f and the support 20 at rim portions of the pair of fixed portions 32, thereby retaining the pair of fixed portions 32 inside the casing 201 and hermetically sealing the periphery of the housing space S.

The third elastic portion 333 is a film parallel to the XZ-plane. The film couples the first elastic portion 331 and the second elastic portion 332 to each other. The third elastic portion 333 is formed between at least a part of the top and back surfaces of the pair of fixed portions 32 and the curve portion 331a. Accordingly, the movable portion 31 is set to be relatively movable in the above-mentioned six axis directions with respect to the pair of fixed portions 32 sandwiched between the frame portion 201f and the support 20.

The gasket member 30 further includes a pair of restriction portions 34 opposite to each other in the Z-axis direction with the movable portion 31 provided therebetween. The pair of restriction portions 34 is rod-like molded bodies extending in the X-axis direction and is supported by the third elastic portion 333 outside the curve portion 331a. FIG. 8 is a cross-sectional view similar to FIG. 3 showing an operation example of the input device 100. The pair of restriction portions 34 is respectively arranged at positions with which the second flat plate portion 13b of the projection 13 comes into contact when the operation key 10 is tilted by a predetermined angle around the X-axis, by supporting the movable portion 31 as a support point. In addition, the pair of restriction portions 34 comes into contact with a rim portion of the switch element 21 when it is pressed in the Y-axis direction from the second flat plate portion 13b, thereby functioning to restricting a tilt of the operation key 10 around the Y-axis by the predetermined angle or more.

### Operation of Input Device

Next, an operation of the input device 100 according to the present embodiment configured in the above-mentioned manner will be described.

During a non-operation of the input device 100, the operation key 10 is, as shown in FIG. 2, arranged in an opening portion 201h of the casing 201 in a state in which the movable portion 31 of the gasket member 30 has been displaced toward the switch element 31 by a predetermined amount. In this state, the operation key 10 is biased upwards in FIG. 2 due to an elastic force of the deformation layer 33 of the gasket member 30 and the pair of flange portions 12 are held in contact with a rim portion of the opening portion 201h, such that an amount of projection from the opening portion 201h is defined.

When the user presses the operation key 10 in the Y-axis direction from the state shown in FIG. 2, the operation key 10 moves the movable portion 31 toward the switch element 21 against the elastic force of the gasket member 30. Then, the protrusion portion 31a of the bottom portion of the movable portion 31 comes into contact with the pressure-sensitive portion 21a of the switch element 21 and its contact pressure reaches the detected pressure of the switch element 21. Then, the switch element 21 is closed and the output is sent to the control unit (not shown). Accordingly, the electronic apparatus 200 detects an input to the input device 100 (in the present embodiment, the camera key 232) and activates a camera application.

In the present embodiment, the pair of fixed portions 32 of the gasket member 30 is provided with the recess portions 32a that allow the pair of flange portions 12 to enter the recess portions 32a when the operation key is pressed 10. Therefore, it is possible to prevent the contact between these flange portions 12 and the fixed portion 32 from obstructing the contact between the movable portion 31 and the switch element 21. That is, also in a case where the housing space S in which the input device 100 is arranged is formed in a limited region inside the casing 201, a stroke required for the press operation on the operation key 10 is ensured and favorable operability of the input device 100 can be realized. In particular, in accordance with the present embodiment, it is possible to place the input device 100 with a long stroke in the thickness dimension of the electronic apparatus 200.

Moreover, in accordance with the present embodiment, the contact action between the second flat plate portion 13b provided in the bottom portion of the operation key 10 and the pair of restriction portions 34 provided in the gasket member 30 can restrict a tilt of the operation key 10 around the X-axis by a predetermined angle or more at the time of a press operation on the operation key 10 (see FIG. 8). Accordingly, it is possible to prevent the operation key 10 from being embedded in the opening portion 201h which can be generated in a case where it excessively tilts around the X-axis of the operation key 10 at the time of the press operation on the input device 100 and to stably restore to a non-operation position (shown in FIG. 2) of the operation key 10 after the operation is cancelled. Such action and effect can be more significantly obtained in particular in a case where the operation key 10 is arranged in one side surface portion of a thin electronic apparatus 200.

In addition, in accordance with the present embodiment, even if the operation key 10 tilts around the Z-axis at the time of the press operation to the operation key 10, the operation key 10 can be prevented from falling with the movable portion 31 as a support point.

For example, if the operation key 10 falls with the movable portion 31 as a support point, the flange portion 12 on the falling side comes into contact with the fixed portion 32 opposite to it or the second flat plate portion 13b provided in the bottom portion of the operation key 10 comes into contact with the restriction portion 34 of the gasket member 30 opposite to it before the switch element 21 detects a contact with the movable portion 31, such that it may be impossible to push the operation key 10 beyond it. In this regard, in the present embodiment, the depth of the recess portion 32a in the Y-axis direction is defined so that the flange portion 12 on the side that has fallen comes into contact with the fixed portion 32 opposite to it before the switch element 21 detects a contact with the movable portion 31 and the length of the second flat plate portion 13b in the X-axis direction is defined so that the second flat plate portion 13b provided in the bottom portion of the operation key 10 does not come into contact with the restriction portion 34 of the gasket member 30 opposite to it before the switch element 21 detects a contact with the movable portion 31 (see FIG. 4). Therefore, even if the operation key 10 is pressed in an attitude tilted around the Z-axis, falling of the operation key 10 with the movable portion 31 as a support can be effectively restricted, and the movable portion 31 can come into contact with the switch element 21 before the flange portion 12 comes into contact with the fixed portion 32 and before the second flat plate portion 13b of the operation key 10 comes into contact with the restriction portion 34 of the gasket member 30.

### MODIFIED EXAMPLES

Although in the above-mentioned embodiment, the description has been made taking the camera key 232 as an example of the input device 100, the present technology is not limited thereto. The present technology may be applied to another key such as the power key 231.

Moreover, the gasket member 30 is not limited to the case where the gasket member 30 is individually arranged in each input device 100, and the gasket member 30 may also be used as a gasket member for another adjacent input device. In this case, movable portions 31, fixed portions 32, and deformation layers 33 corresponding to the respective input devices may be individually provided in the single gasket member 30.

Moreover, although in the above-mentioned embodiment, the description has been made taking the smartphone as an example of the electronic apparatus 200, the present technology is not limited thereto. The present technology can also be applied to another electric apparatus such as a video camera or a laptop PC.

It should be noted that the present technology may also take the following configurations.
(1) An electronic apparatus, including:
   a casing with an opening portion long in a first axis direction and short in a second axis direction orthogonal to the first axis;
   an operation key including
      a key body that is fitted in the opening portion and is long in the first axis direction, and
      a pair of flange portions respectively provided at both ends of the key body in a long direction and projecting in parallel with the first axis direction inside the casing;
   a support that is arranged inside the casing and includes a switch element for detecting a press operation on the operation key in a third axis direction orthogonal to the first axis and the second axis; and
   a gasket member including
      a movable portion that is arranged between the key body and the switch element and receives a pressing force along the third axis direction from the operation key and comes into contact with the switch element,
      a pair of fixed portions that is arranged between the casing and the support and respectively includes recess portions that the pair of flange portions enters at a time of the press operation on the operation key, and
      a deformation layer that supports the movable portion and the pair of fixed portions and is formed of an elastic material.
(2) The electronic apparatus according to (1), wherein
   the deformation layer includes
      a first elastic portion that supports the movable portion and biases the operation key in a direction away from the switch element, and
      a pair of second elastic portions that supports the pair of fixed portions and seals a gap between the casing and the support.
(3) The electronic apparatus according to (2), wherein
   the first elastic portion has a curve portion which is provided in an annular shape along a periphery of the movable portion and has a shape protruding toward the key body.
(4) The electronic apparatus according to (2) or (3), wherein
   the gasket member further includes a pair of restriction portions that is opposite to each other in the second axis direction with the movable portion provided therebetween and restricts a tilt of the key body around the first axis.
(5) The electronic apparatus according to (4), wherein
   the operation key further includes a projection that comes into contact with the movable portion provided in a bottom portion of the key body, and
   the projection includes
      a first flat plate portion extending in the first axis direction, and
      a second flat plate portion intersecting with the first flat plate portion and extending in the second axis direction.
(6) The electronic apparatus according to any one of (1) to (5), wherein
   the casing includes a length direction in parallel with the first axis direction, a thickness direction in parallel with the second axis direction, and a width direction in parallel with the third axis direction, and
   the opening portion is formed in one side surface portion of the casing.
(7) An input device, which is a switch device arranged in a casing with an opening portion long in a first axis direction and short in a second axis direction orthogonal to the first axis, including:
   an operation key including
      a key body that is fitted in the opening portion and is long in the first axis direction, and
      a pair of flange portions respectively provided at both ends of the key body in a long direction and projecting in parallel with the first axis direction inside the casing;
   a support that is arranged inside the casing and installs a switch element for detecting a press operation on the operation key in a third axis direction orthogonal to the first axis and the second axis; and
   a gasket member including
      a movable portion that is arranged between the key body and the switch element and receives a pressing force along the third axis direction from the operation key and comes into contact with the switch element,
      a pair of fixed portions that is arranged between the casing and the support and respectively includes recess portions that the pair of flange portions enters at a time of the press operation on the operation key, and
      a deformation layer that supports the movable portion and the pair of fixed portions and is formed of an elastic material.

### REFERENCE SIGNS LIST

10 operation key
11 key body
12 flange portion
13 projection
13a first flat plate portion
13b second flat plate portion
20 support
21 switch element
30 gasket member
31 movable portion
32 fixed portion
33 deformation layer
34 restriction portion
100 input device
200 electronic apparatus
201 casing
331 first elastic portion
331a curve portion
332 second elastic portion
333 third elastic portion

1. An electronic apparatus, comprising:
a casing with an opening portion long in a first axis direction and short in a second axis direction orthogonal to the first axis;
an operation key including
a key body that is fitted in the opening portion and is long in the first axis direction, and
a pair of flange portions respectively provided at both ends of the key body in a long direction and projecting in parallel with the first axis direction inside the casing;
a support that is arranged inside the casing and includes a switch element for detecting a press operation on the operation key in a third axis direction orthogonal to the first axis and the second axis; and
a gasket member including
a movable portion that is arranged between the key body and the switch element and receives a pressing force along the third axis direction from the operation key and comes into contact with the switch element,
a pair of fixed portions that is arranged between the casing and the support and respectively includes recess portions that the pair of flange portions enters at a time of the press operation on the operation key, and
a deformation layer that supports the movable portion and the pair of fixed portions and is formed of an elastic material.

2. The electronic apparatus according to claim 1, wherein
the deformation layer includes
a first elastic portion that supports the movable portion and biases the operation key in a direction away from the switch element, and
a pair of second elastic portions that supports the pair of fixed portions and seals a gap between the casing and the support.

3. The electronic apparatus according to claim 2, wherein
the first elastic portion has a curve portion which is provided in an annular shape along a periphery of the movable portion and has a shape protruding toward the key body.

4. The electronic apparatus according to claim 2, wherein
the gasket member further includes a pair of restriction portions that is opposite to each other in the second axis direction with the movable portion provided therebetween and restricts a tilt of the key body around the first axis.

5. The electronic apparatus according to claim 4, wherein
the operation key further includes a projection that comes into contact with the movable portion provided in a bottom portion of the key body, and
the projection includes
a first flat plate portion extending in the first axis direction, and
a second flat plate portion intersecting with the first flat plate portion and extending in the second axis direction.

6. The electronic apparatus according to claim 1, wherein
the casing includes a length direction in parallel with the first axis direction, a thickness direction in parallel with the second axis direction, and a width direction in parallel with the third axis direction, and
the opening portion is formed in one side surface portion of the casing.

7. An input device, which is a switch device arranged in a casing with an opening portion long in a first axis direction and short in a second axis direction orthogonal to the first axis, comprising:
an operation key including
a key body that is fitted in the opening portion and is long in the first axis direction, and
a pair of flange portions respectively provided at both ends of the key body in a long direction and projecting in parallel with the first axis direction inside the casing;
a support that is arranged inside the casing and installs a switch element for detecting a press operation on the operation key in a third axis direction orthogonal to the first axis and the second axis; and
a gasket member including
a movable portion that is arranged between the key body and the switch element and receives a pressing force along the third axis direction from the operation key and comes into contact with the switch element,
a pair of fixed portions that is arranged between the casing and the support and respectively includes recess portions that the pair of flange portions enters at a time of the press operation on the operation key, and
a deformation layer that supports the movable portion and the pair of fixed portions and is formed of an elastic material.
